(19) United States
(12) Patent Application Publication
(10) Pub. No.: US 2026/0239427 A1
(43) Pub. Date: Aug. 13, 2026

(54) PACKET TRANSMISSION WITH POWER CONTROLLED COORDINATED SPATIAL REUSE

(71) Applicant: NXP USA, Inc., AUSTIN, TX (US)

(72) Inventors: Sayak Roy, Kolkata (IN); Ankit Sethi, Pune (IN); Rui Cao, Sunnyvale, CA (US); Liwen Chu, San Ramon, CA (US); Sudhir Srinivasa, Los Gatos, CA (US)

(21) Appl. No.: 19/537,639

(22) Filed: Feb. 12, 2026

(30) Foreign Application Priority Data
Feb. 12, 2025 (IN) 202541011720

(51) Int. Cl. H04W 74/0816; H04W 74/08; H04W 76/10

(52) U.S. Cl. CPC H04W 74/0816; H04W 74/0891; H04W 76/10

(57) ABSTRACT

Methods and apparatus are described for performing Coordinated Spatial Reuse (CoSR) downlink data transmissions by access points of a wireless network. In an embodiment, a first access point (AP) (e.g., a sharing AP) transmits CoSR-related control information to establish a CoSR session with a second AP (e.g., a shared AP) and further transmits a Trigger frame for packet synchronization with the second AP. The first AP further transmits a Request to Send (RTS) frame having a duration field set to a remaining amount of time of a transmission opportunity (TXOP) of the first AP and receives, in response to the RTS frame, a Clear to Send (CTS) frame from the second AP. The first AP further transmits a data PPDU. The CoSR-related control information directs the second AP to transmit a synchronized data PPDU at a reduced power level that is less than the power level of the CTS frame.

### CROSS REFERENCE TO RELATED APPLICATIONS

The present U.S. Utility Patent Application claims priority pursuant to 35 U.S.C. § 119(a) to Indian Provisional Patent Application Number 202541011720, entitled “PROTOCOL AND SIGNALLING FOR PACKET TRANSMISSION IN POWER CONTROLLED COORDINATED SPATIAL REUSE”, filed Feb. 12, 2025, the contents of which are incorporated herein by reference in its entirety and made part of the present U.S. Utility Patent Application for all purposes.

### TECHNICAL FIELD

This disclosure relates generally wireless communications, and more specifically to coordinated spatial reuse between devices of a wireless network.

### BACKGROUND

Wireless local area networks (WLANs) have evolved rapidly over the past couple of decades, including WLANs that conform to the Institute of Electrical and Electronics Engineers (IEEE) 802.11 family of standards. A typical 802.11-based WLAN may be formed by one or more access points (APs) that provide a shared wireless communication medium for servicing a number of client devices or stations (STAs). In particular, an AP manages a Basic Service Set (BSS) that is identified by a Basic Service Set Identifier (BSSID) and advertised by the AP. The AP periodically broadcasts beacon frames to enable STAs within wireless range of the AP to establish and maintain communication links with the AP.

Multi-AP coordination is anticipated to be a significant advancement in the IEEE 802.11 standard. Current development focuses on coordinated mechanisms that allow access points APs to act collaboratively and intelligently instead of functioning as independent nodes.

### SUMMARY

The innovative methods and apparatus illustrated in the drawings and described herein provide for Coordinated Spatial Reuse (CoSR) protocols and signaling to support simultaneous downlink data transmissions from multiple APs by coordinating transmit powers and scheduling to reduce co-channel interference. In an illustrative, non-limiting embodiment, a method for performing a CoSR downlink data transmission by a first access point (AP) of a wireless network is provided. The method includes transmitting CoSR-related control information to establish a CoSR session with a second AP and transmitting a Trigger frame for packet synchronization with the second AP. The method further includes transmitting a Request to Send (RTS) frame having a duration field set to a remaining amount of time of a transmission opportunity (TXOP) of the first AP. The method further includes receiving, in response to the RTS frame, a Clear to Send (CTS) frame from the second AP, wherein the CTS frame is transmitted at a first power level. The method further includes transmitting a data physical layer protocol data unit (PPDU), wherein the CoSR-related control information from the first AP directs the second AP to transmit a synchronized data PPDU at a reduced power level that is less than the first power level of the CTS frame.

The method of this embodiment includes optional aspects. With one optional aspect, transmitting CoSR-related control information to the second AP includes transmitting a CoSR Initial Control Frame (ICF) and, in response to the ICF, receiving a CoSR Initial Control Response frame (ICR) from the second AP. With another optional aspect, the data PPDU transmitted by the first AP includes a universal signaling (U-SIG) field including a U-SIG-1 field and a U-SIG-2 field, wherein the U-SIG-1 field includes first bits corresponding to a Basic Service Set (BSS) color of the first AP and second bits corresponding to a BSS color of the second AP, and the U-SIG-2 field includes one or more bits set to indicate that the data PPDU is a Single User (SU) PPDU. In another optional aspect, the synchronized data PPDU transmitted by the second AP includes a U-SIG field including a U-SIG-1 field and a U-SIG-2 field, wherein the U-SIG-1 field includes bits corresponding to the BSS color of the first AP and second bits corresponding to the BSS color of the second AP, and the U-SIG-2 field includes one or more bits set to indicate that the synchronized data PPDU is a Single User (SU) PPDU.

In another optional aspect, the data PPDU transmitted by the first AP and the synchronized data PPDU transmitted by the second AP further include a UHR-SIG common field having one or more bits set to disable Overlapping BSS Packet Detection (OBSS/PD) and Parameterized Spatial Reuse (PSR) operations. In a further optional aspect, the U-SIG-2 field of the data PPDU and the U-SIG-2 field of the synchronized data PPDU transmitted by the second AP further include one or more bits set to indicate a CoSR PPDU. In yet another optional aspect, the data PPDU transmitted by the first AP includes a U-SIG-1 field including PHY version identifier bits set to 0, first bits corresponding to an Extremely High Throughput (EHT) Basic Service Set (BSS) color and second bits corresponding to a Ultra High Reliability (UHR) BSS color. In this optional aspect, the data PPDU further includes a U-SIG-2 field including two bits set to indicate that the data PPDU is a Single User (SU) PPDU.

In another optional aspect, the data PPDU is intended for an EHT STA and further includes an EHT-SIG common field having bit index [0-3] set to disable Overlapping BSS Packet Detection (OBSS/PD) and Parameterized Spatial Reuse (PSR) operations and bit index [17-19] set to indicate that the data PPDU is a Single User (SU) PPDU. In a further optional aspect, the data PPDU is intended for a UHR STA and further includes an EHT-SIG common field having bit index [0-3] set to a reserved value that indicates a CoSR PPDU and bit index [17-19] set to indicate that the data PPDU is a Single User (SU) PPDU. In yet another optional aspect, the CoSR downlink data transmissions are asynchronous, and the data PPDU transmitted by the first AP includes a universal signaling (U-SIG) field including a U-SIG-1 field and a U-SIG-2 field, wherein the U-SIG-1 field includes first bits corresponding to a Basic Service Set (BSS) color of the first AP and second bits corresponding to a BSS color of the second AP, and the U-SIG-2 field includes one or more bits set to indicate that the data PPDU is a Single User (SU) PPDU. In this optional aspect, the data PPDU further includes a UHR-SIG field that includes at least four symbols. With another optional aspect, the first AP is a sharing AP with respect to a transmission opportunity (TXOP) that includes the CoSR session, and the second AP is a shared AP with respect to the TXOP.

With another illustrative, non-limiting embodiment, a method for performing a CoSR downlink data transmission by a first access point (AP) of a wireless network is provided. The method includes transmitting CoSR-related control information to establish a CoSR session with a second AP. The method of this embodiment further includes transmitting a first Clear to Send (CTS) frame having a duration field set to a remaining amount of time of a transmission opportunity (TXOP) of the first AP beginning one SIFS duration after the transmission time of the first CTS frame, the first CTS frame further having a Receiver Address (RA) field set to a MAC address of the first AP. The method further includes transmitting a data physical layer protocol data unit (PPDU), wherein the CoSR-related control information from the first AP directs the second AP to: transmit a second CTS frame concurrently with the first CTS frame, the second CTS frame having a duration field set to a remaining amount of time of the TXOP and a RA field set to the MAC address of the first AP; and transmit a CoSR data PPDU, wherein the second CTS frame is transmitted at a full power level and the CoSR data PPDU is transmitted at a reduced power level.

The method of this embodiment includes optional aspects. With one optional aspect, transmitting CoSR-related control information to the second AP includes transmitting a CoSR Initial Control Frame (ICF) and, in response to the ICF, receiving a CoSR Initial Control Response frame (ICR) from the second AP. In another optional aspect, the data PPDU transmitted by the first AP includes a universal signaling (U-SIG) field including a U-SIG-1 field and a U-SIG-2 field, wherein the U-SIG-1 field includes first bits corresponding to a Basic Service Set (BSS) color of the first AP and second bits corresponding to a BSS color of the second AP, and the U-SIG-2 field includes one or more bits set to indicate that the data PPDU is a Single User (SU) PPDU. In yet another optional aspect, the CoSR PPDU transmitted by the second AP includes a U-SIG field including a U-SIG-1 field and a U-SIG-2 field, wherein the U-SIG-1 field includes bits corresponding to the BSS color of the first AP and second bits corresponding to the BSS color of the second AP, and the U-SIG-2 field includes one or more bits set to indicate that the synchronized data PPDU is a Single User (SU) PPDU.

With another illustrative, non-limiting embodiment, an access point (AP) includes one or more wireless transceivers and one or more processors operably coupled to the one or more of wireless transceivers. The one or more processors modules are arranged to transmit CoSR-related control information to establish a CoSR session with a second AP, transmit a Trigger frame for packet synchronization with the second AP, transmit a Request to Send (RTS) frame having a duration field set to a remaining amount of time of a transmission opportunity (TXOP) of the AP, and receive, in response to the RTS frame, a Clear to Send (CTS) frame from the second AP, wherein the CTS frame is transmitted at a first power level. The one or more processors modules are further arranged to transmit a data physical layer protocol data unit (PPDU), wherein the CoSR-related control information from the sharing AP directs the second AP to transmit a synchronized data PPDU at a reduced power level that is less than the first power level of the CTS frame

This third embodiment includes optional aspects. With one optional aspect, transmitting CoSR-related control information to the second AP includes transmitting a CoSR Initial Control Frame (ICF) and, in response to the ICF, receiving a CoSR Initial Control Response frame (ICR) from the second AP. In another optional aspect, the data PPDU transmitted by the AP includes a universal signaling (U-SIG) field including a U-SIG-1 field and a U-SIG-2 field, wherein the U-SIG-1 field includes first bits corresponding to a Basic Service Set (BSS) color of the AP and second bits corresponding to a BSS color of the second AP, and the U-SIG-2 field includes one or more bits set to indicate that the data PPDU is a Single User (SU) PPDU.

In another optional aspect, the data PPDU transmitted by the AP further includes a UHR-SIG common field having one or more bits set to disable Overlapping BSS Packet Detection (OBSS/PD) and Parameterized Spatial Reuse (PSR) operations. In a further optional aspect, the synchronized data PPDU transmitted by the second AP includes a U-SIG field including a U-SIG-1 field and a U-SIG-2 field, and wherein the U-SIG-1 field includes bits corresponding to the BSS color of the AP and second bits corresponding to the BSS color of the second AP, and the U-SIG-2 field includes one or more bits set to indicate that the synchronized data PPDU is a Single User (SU) PPDU.

### BRIEF DESCRIPTION OF THE DRAWINGS

FIG. 1 illustrates an example of a multi-link communications system in accordance with embodiments of the present disclosure;

FIG. 2 illustrates an example of wireless local area network (WLAN) including a sharing access point and a shared access point in accordance with embodiments of the present disclosure;

FIG. 3 illustrates an example of a frame exchange sequence for a power controlled Coordinated Spatial Reuse (CoSR) session in accordance with an embodiment of the present disclosure;

FIG. 4 illustrates another example of a frame exchange sequence for a power controlled CoSR session in accordance with an embodiment of the present disclosure;

FIG. 5 illustrates examples of CoSR downlink data PPDU preamble signal fields and power control in accordance with embodiments of the present disclosure;

FIG. 6 illustrates an example of UHR PPDU preamble signal fields in accordance with embodiments of the present disclosure;

FIG. 7 illustrates examples of PPDU preamble signal fields that accommodate an EHR station in accordance with an embodiment of the present disclosure;

FIG. 8 illustrates an example of a protocol for asynchronous CoSR in accordance with an embodiment of the present disclosure;

FIG. 9 is a flow chart illustrating an example method for performing a CoSR frame exchange in accordance with embodiments of the present disclosure; and

FIG. 10 illustrates an example of a wireless device according to embodiments of the present disclosure.

### DETAILED DESCRIPTION

In general, Coordinated Spatial Reuse CoSR is a technique that allows multiple APs to transmit at the same time on the same channel by coordinating transmit powers, sensitivity thresholds, and scheduling to reduce co-channel interference. Such coordination is expected to increase spectral efficiency and enable significantly higher throughput in dense Wi-Fi deployments.

The various implementations described in the following description relate generally to frame exchange protocols and updated physical layer protocol data unit (PPDU) formats (e.g., such as may be defined in the IEEE 802.11bn amendment to the IEEE 802.11 standard) for performing CoSR operations between access points of a wireless network. In particular, various methods are described to provide medium protection during synchronous CoSR where a shared AP controls transmission power. In addition, signaling protocols are provided for enabling legacy devices (e.g., 802.11be client stations) to participate in a CSR opportunity. In further embodiments, protocols are disclosed for mitigating symbol timing issues in asynchronous CoSR and avoiding undesired packet detection during synchronized PPDU transmissions.

Particular embodiments of the subject matter described in the present disclosure can be implemented to realize one or more of the following potential advantages. By managing and reducing co-channel interference and channel contention, the protocols and signaling formats described herein help enable gains in overall network throughput (particularly in high-density environments) that will be achievable in accordance with IEEE 802.11bn. The disclosed embodiments also enable more consistent performance and reduced communication latency, supporting the requirements of high-bandwidth, real-time, and low-latency applications such as gaming, AR/VR, robotics, industrial automation, etc.

As used herein, the term “sharing AP” refers to an AP which obtains a TXOP and initiates or participates in a TXOP sharing process, and the term “shared AP” refers to an AP that initiates or participates in a TXOP sharing process to obtain a shared portion or time allocation of a TXOP obtained by another AP within its range. Any AP that obtains a TXOP can become a sharing AP.

As used herein, the term “non-legacy” may refer to physical layer protocol data unit (PPDU) formats and communication protocols conforming with the IEEE 802.11bn amendment to the IEEE 802.11 standard (also referred to as Ultra High Reliability or “UHR”, “Wi-Fi 8”, or “802.11bn”) as well as future generations/amendments. In contrast, the term “legacy” may be used herein to refer to PPDU formats and communication protocols conforming to the IEEE 802.11be (also referred to as Extremely High Throughput or “EHT” or “Wi-Fi 7”) or IEEE 802.11ax (also referred to as High Efficiency or “HE” or “Wi-Fi 6/6E”) amendments to the IEEE 802.11 standard, or earlier generations of the IEEE 802.11 standard, but not conforming to all mandatory features of 802.11bn or future generations of the IEEE 802.11 standard. In some implementations, the frame formats described herein may be configurable to support multiple versions of the IEEE 802.11 standard.

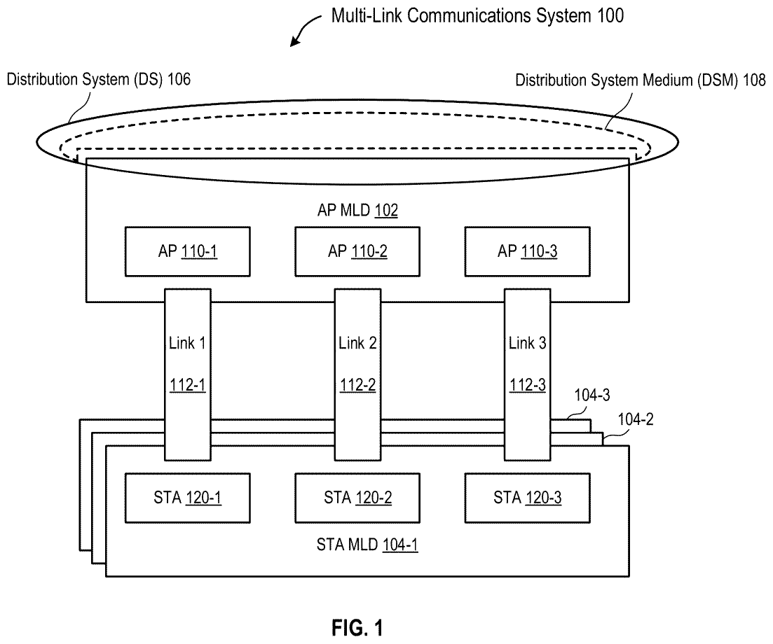

FIG. 1 illustrates an example of a multi-link (ML) communications system 100 in accordance with embodiments of the present disclosure. The illustrated multi-link communications system 100 includes at least one AP multi-link device (MLD) 102 and one or more non-AP multi-link devices, which are, for example, implemented as station (STA) MLDs 104-1, 104-2, and 104-3. The multi-link communications system 100 can be used in various applications, such as industrial applications, medical applications, computer applications, and/or consumer or appliance applications. In the illustrated example, the multi-link communications system is a wireless communications system compatible with an IEEE 802.11 standard. Although the depicted multi-link communications system 100 is shown in FIG. 1 with certain components and described with certain functionality herein, other embodiments of the multi-link communications system 100 may include fewer or more components to implement the same, less, or more functionality. For example, although the multi-link communications system 100 shown in FIG. 1 includes the AP MLD 102 and the STA MLDs 104-1, 104-2, and 104-3, in other embodiments, the multi-link communications system includes other multi-link devices, such as multiple AP MLDs and multiple STA MLDs, or a single AP MLD and a single STA MLD. In another example, the multi-link communications system includes more than three STA MLDs and/or less than three STA MLDs. Although the multi-link communications system 100 is shown in FIG. 1 as being connected in a certain topology, the network topology of the multi-link communications system 100 is not limited to the topology shown in FIG. 1.

In the embodiment depicted in FIG. 1, the AP MLD 102 includes multiple radios, implemented as APs 110-1, 110-2, and 110-3. In some embodiments, the AP MLD 102 is an AP multi-link logical device or an AP multi-link logical entity (MLLE). In some embodiments, a common part of the AP MLD 102 implements upper layer Media Access Control (MAC) functionalities that are common to multiple links (e.g., association establishment, reordering of frames, etc.) and a link specific part of the AP MLD 102, i.e., the APs 110-1, 110-2, and 110-3, implement the upper layer functionalities specific to a link and lower layer MAC functionalities (e.g., beaconing, backoff, frame transmission, frame reception, etc.). The APs 110-1, 110-2, and 110-3 may be implemented in hardware (e.g., circuits), software, firmware, or a combination thereof. At least one of the APs 110-1, 110-2, or 110-3 may be fully or partially implemented as an integrated circuit (IC) device. In some embodiments, the AP MLD and its affiliated APs 110-1, 110-2, and 110-3 are compatible with at least one WLAN communications standard (e.g., at least one IEEE 802.11 standard). For example, the APs 110-1, 110-2, and 110-3 may be wireless APs compatible with at least one non-legacy IEEE 802.11 standard (e.g., 802.11bn).

In some embodiments, an AP MLD (e.g., the AP MLD 102) is connected to a local network (e.g., a local area network (LAN)) and/or to a backbone network (e.g., the Internet) through a wired connection and wirelessly connects to wireless STA MLDs, for example, through one or more WLAN communications standards, such as an IEEE 802.11 standard. In some embodiments, an AP (e.g., the AP 110-1, the AP 110-2, and/or the AP 110-3) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. The at least one controller may be implemented within a processor(s), such as a microcontroller, a host processor, a host, a digital signal processor (DSP), processing module, or a central processing unit (CPU), which can be integrated in a corresponding transceiver.

Each of the APs 110-1, 110-2, and 110-3 of the AP MLD 104 may operate in different frequency bands. For example, at least one of the APs 110-1, 110-2, or 110-3 of the AP MLD 104 operates in an Extremely High Frequency (EHF) band or the “millimeter wave (mmWave)” frequency band. In some embodiments, the mmWave frequency band is a band of radio wave frequencies between 30 Gigahertz (GHz) and 300 GHz. For example, a mmWave link may operate in a 45 GHz or 60 GHz frequency band. In a specific example, the AP 110-1 may operate in a 6 GHz band (e.g., with a 320 MHz Basic Service Set (BSS) operating channel or other suitable BSS operating channel), the AP 110-2 may operate in a 2.4/5 GHz band (e.g., with a 20/40/80/160 MHz BSS operating channel or other suitable BSS operating channel), and the AP 110-3 may operate in a 60 GHz band (e.g., with a 160 MHz BSS operating channel or other suitable BSS operating channel).

In the illustrated embodiment, the AP MLD is connected to a distribution system (DS) 106 through a distribution system medium (DSM) 108. The distribution system (DS) 106 may be a wired network or a wireless network that is connected to a backbone network such as the Internet. The DSM 108 may be a wired medium (e.g., Ethernet cables, telephone network cables, or fiber optic cables) or a wireless medium (e.g., infrared, broadcast radio, cellular radio, or microwaves). Although the AP MLD 102 is shown in FIG. 1 as including three APs, other embodiments of the AP MLD 102 may include fewer than three APs or more than three APs. In addition, although some examples of the DSM 108 are described, the DSM 108 is not limited to the examples described herein.

In the embodiment depicted in FIG. 1, the STA MLD 104-1 (non-AP MLD) includes radios, which are implemented as multiple non-AP stations (STAs) 120-1, 120-2, and 120-3. The STAs 120-1, 120-2, and 120-3 may be implemented in hardware (e.g., circuits), software, firmware, or a combination thereof. At least one of the STAs 120-1, 120-2, and 120-3 may be fully or partially implemented as an IC device. In some embodiments, the non-AP STAs 120-1, 120-2, and 120-3 are part of the STA MLD 104-1, such that the STA MLD may be a communications device that wirelessly connects to an AP MLD, such as, the AP MLD 102. For example, the STA MLD 104-1 (e.g., at least one of the non-AP STAs 120-1, 120-2 or 120-3) may be implemented in a laptop, a desktop computer, a mobile phone, or other communications device that supports at least one WLAN communications standard. In some embodiments, the STA MLD and its affiliated STAs 120-1, 120-2, and 120-3 are compatible with at least one IEEE 802.11 standard. In an example, each of the non-AP STAs 120-1, 120-2, and 120-3 includes at least one antenna, at least one transceiver operably connected to the at least one antenna, and at least one controller connected to the corresponding transceiver. The at least one transceiver may include a PHY device. The at least one controller can be configured to control the at least one transceiver to process received packets through the at least one antenna. In some embodiments, the at least one controller is implemented by a processor, such as a microcontroller, a host processor, a host, a DSP, processing module, or a CPU, which can be integrated in a corresponding transceiver. In an example, the STA MLD has one MAC data service interface. In another example, a single address is associated with the MAC data service interface and is used to communicate on the DSM 108. In some embodiments, the STA MLD 104-1 implements a common MAC data service interface and the non-AP STAs 120-1, 120-2, and 120-3 implement a lower layer MAC data service interface.

In an example, the AP MLD 102 and/or the STA MLDs 104-1, 104-2, and 104-3 identify which communications links support the multi-link operation during a multi-link operation setup phase and/or exchanges information regarding multi-link capabilities during the multi-link operation setup phase. In addition, each of the STAs 120-1, 120-2, and 120-3 of the STA MLD may operate in the same frequency band or different frequency bands. For example, at least one of the STAs 120-1, 120-2, or 120-3 of the STA MLD 104-1 operates in the mmWave frequency band (e.g., a 45 GHz or 60 GHz frequency band). In an example, the STA 120-1 may operate in a 6 GHz band (e.g., with a 320 MHz BSS operating channel or other suitable BSS operating channel), the STA 120-2 may operate in a 2.4/5 GHz band (e.g., with a 20/40/80/160 MHz BSS operating channel or other suitable BSS operating channel), and the STA 120-3 may operate in a 60 GHz band (e.g., with a 640 MHz BSS operating channel or other suitable BSS operating channel). Although the STA MLD 104-1 is shown in FIG. 1 as including three non-AP STAs, other embodiments of the STA MLD 104-1 may include fewer than three non-AP STAs or more than three non-AP STAs.

Each of the MLDs 104-2, 104-3 may be the same as or similar to the STA MLD 104-1. For example, the MLD 104-2 and 104-3 include one or multiple non-AP STAs. In some embodiments, each of the non-AP STAs includes at least one antenna, at least one transceiver operably connected to the at least one antenna, and at least one controller connected to the corresponding transceiver. In some embodiments, the at least one transceiver includes a PHY device. The at least one controller can be configured to control the at least one transceiver to process received packets through the at least one antenna. In some embodiments, the at least one controller is implemented by a processor, such as a microcontroller, a host processor, a host, a DSP, a processing module, or a CPU, which can be integrated in a corresponding transceiver.

In the illustrated network, the STA MLD 104-1 communicates with the AP MLD 102 through multiple communications links 112-1, 112-2, 112-3. For example, each of the STAs 120-1, 120-2, 120-3 communicates with an AP 110-1, 110-2, or 110-3 through a corresponding wireless communications link 112-1, 112-2, or 112-3. Although the AP MLD 102 communicates (e.g., wirelessly communicates) with the STA MLD 104-1 through multiple links 112-1, 112-2, 112-3, in other embodiments, the AP MLD 102 may communicate (e.g., wirelessly communicate) with the STA MLD through more than three communications links or less three than communications links. In some embodiments, the wireless communications links in the multi-link communications system include one or more 2.4 GHz, 5 GHz, 6 GHz, 45 GHz and/or 60 GHz links.

In the embodiment depicted in FIG. 1, the communications links 112-1, 112-2, and 112-3 between the AP MLD and the STA MLD 104-1 may involve at least one mmWave link. For example, the communications links 112-1, 112-2, and 112-3 between the AP MLD 102 and the STA MLD 104-1 include a mmWave link (e.g., a 45/60 GHz link) between an AP of the AP MLD 102 and an STA of the STA MLD 104-1 operating in a mmWave frequency band (e.g., a 45/60 GHz frequency band) and two non-mmWave links (e.g., 2.4 GHz, 5 GHz, or 6 GHz links) and two mmWave links (e.g., a 45 GHz link and a 60 GHz link) between APs of the AP MLD 102 and STAs of the STA MLD 104-1 operating in non-mmWave frequency bands (e.g., 2.4 GHz, 5 GHz, or 6 GHz frequency bands). In another example, the communications links 112-1, 112-2, and 112-3 between the AP MLD 102 and the STA MLD 104-1 include two mmWave links (e.g., 45/60 GHz links) between APs of the AP MLD 102 and STAs of the STA MLD 104-1 operating in mmWave frequency bands (e.g., 45/60 GHz frequency bands) and one non-mmWave link (e.g., a 2.4 GHz, 5 GHz, or 6 GHz link) between an AP of the AP MLD 102 and an STA of the STA MLD 104-1 operating in a non-mmWave frequency bands (e.g., a 2.4 GHz, 5 GHz, or 6 GHz frequency band).

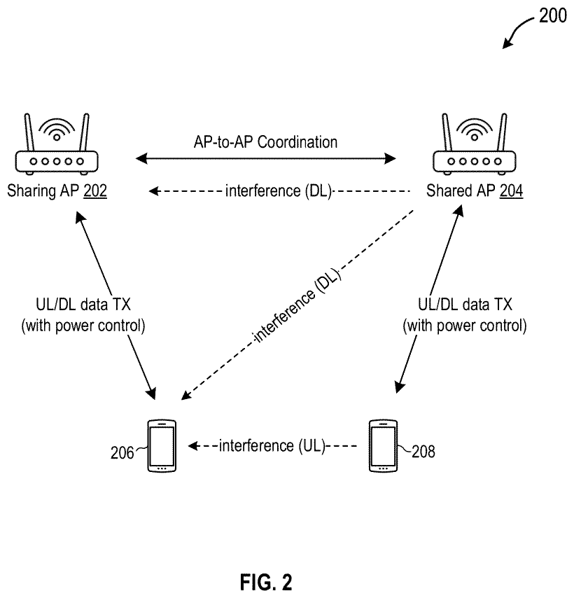

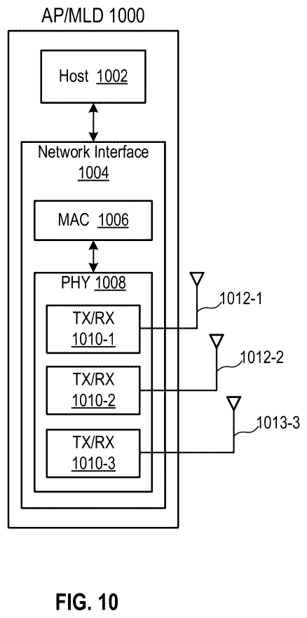

FIG. 2 illustrates an example of wireless local area network (WLAN) including a sharing AP 202 and a shared AP 204 in accordance with embodiments of the present disclosure. In the illustrated example, a client STA 206 is associated with the sharing AP 202 in a first BSS and client STA(s) 208 is associated with the shared AP 204 in a second BSS. One or more of sharing AP 202 and shared AP 204 may be an example of an AP affiliated with an AP MLD 102 of FIG. 1, or an example of the AP/MLD 1000 described with reference to FIG. 10. One or more of STA 206 and STA 208 may be an example of a STA affiliated with a STA MLD 104 of FIG. 1.

In this example, the sharing AP 202 and the shared AP 204 may have varying and overlapping coverage areas (e.g., in a high-density deployment setting) and may communicate directly via a direct wireless link. The sharing AP 202 and the shared AP 204 may operate on overlapping but distinct frequencies and bandwidths. In an example, the sharing AP 202 may obtain or secure a TXOP for an operating bandwidth comprising one or more channels, and the shared AP 204 may utilize one or more of the same channels, but may also operate on further channels that do not overlap with the sharing AP's channels. The sharing AP 202 and the client STA 206 may exchange uplink (UL) data PPDUs and downlink (DL) data PPDUs with power control (e.g., to mitigate co-channel interference), and the shared AP 204 and client STA 206 may exchange uplink (UL) data PPDUs and downlink (DL) data PPDUs with power control.

In the illustrated example, AP-to-AP coordination exchanges between sharing AP 202 and shared AP 204 can be used to negotiate and schedule multi-AP functions such as Coordinated Spatial Reuse (CoSR) sessions. In an example, a CoSR session includes synchronized downlink (DL) data PPDUs transmitted by sharing AP 202 and shared AP 204.

During synchronized packet transmission, there are various potential interference paths between network devices as partially illustrated in FIG. 2. For example, a DL data PPDU transmission from shared AP 204 may cause interference at sharing AP 202 and client STA 206, and potentially cause client STA 206 to drop a synchronized DL packet from sharing AP 202. In another example, an UL data PPDU from a client STA of shared AP 2 (e.g., a non-addressed STA) may cause interference at client STA 206.

While CoSR is intended to manage interference such as shown in FIG. 2, a STA (not separately illustrated) in a BSS of the shared AP 204 (or a nearby OBSS) that is not an intended recipient of a power controlled data PPDU transmitted by the shared AP 204 may miss a control frame exchange used to establish a CoSR session, and may therefore be unaware of an ongoing TXOP that includes the CoSR session. In this instance, the STA may sense the medium during an ongoing data PPDU transmission (at a reduced power level) and incorrectly sense the medium as free. As a result, the STA may initiate a transmission that can interfere with reception of the data PPDU by an intended recipient STA.

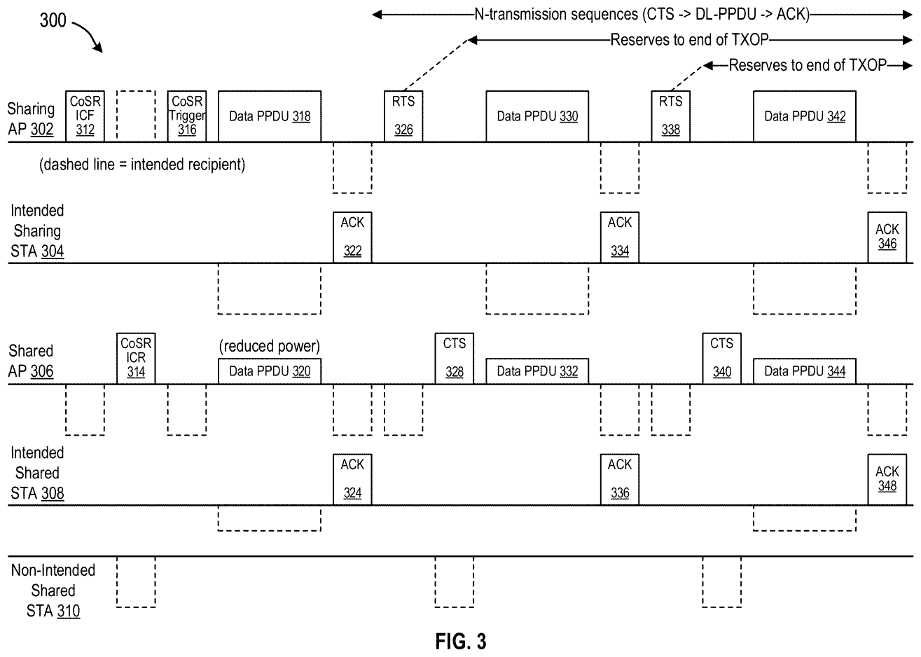

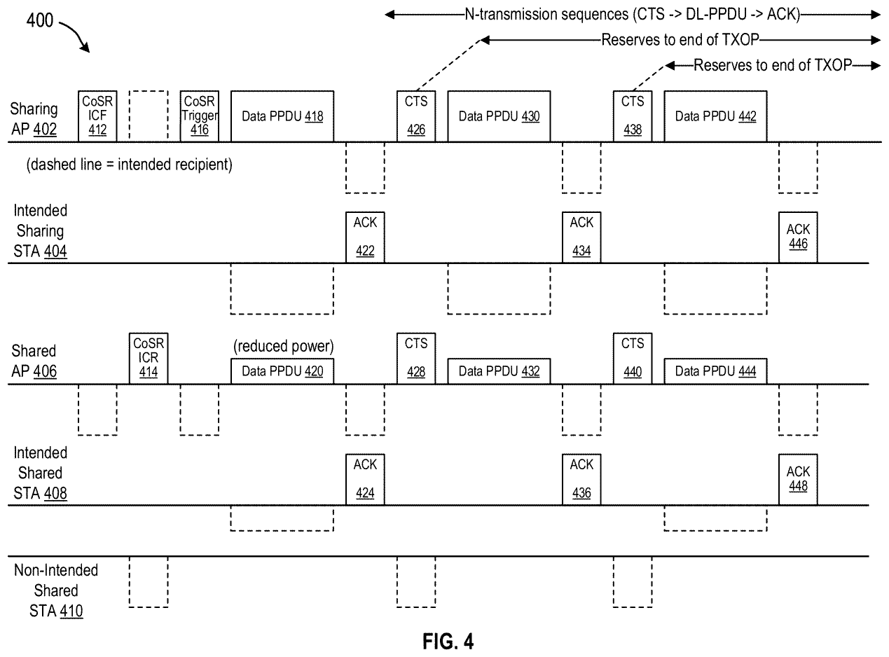

As described more fully below, various protocols are disclosed for protecting a transmission medium in such circumstances. In an example (described more fully with refence to FIG. 3), the sharing AP 202 and shared AP 204 perform a full power RTS/CTS frame exchange prior to transmission of a power controlled data PPDU by the shared AP 204. In another example (described more fully with reference to FIG. 4), the sharing AP 202 and shared AP 204 simultaneously transmit CTS frames at full power prior to transmission of a power controlled data PPDU by the shared AP 204.

FIG. 3 illustrates an example of a frame exchange sequence for a power controlled Coordinated Spatial Reuse (CoSR) session 300 in accordance with an embodiment of the present disclosure. In the illustrated example, the CoSR session 300 is performed between a sharing AP 302, a sharing STA 304 that is an intended recipient of DL data PPDUs from sharing AP 302, a shared AP 306, a shared STA 308 that is an intended recipient of DL data PPDUs from shared AP 306. The example further includes a non-intended shared STA 310 that is a potential source of interference.

In this example, one transmit opportunity (TXOP) of a CoSR session is shown. In general, a TXOP is a designated time duration for which an AP can transmit frames without contention, essentially giving it exclusive access to the wireless medium (or channel) for a set duration without needing to compete with other devices in a BSS. In the illustrated example, the sharing AP 302 obtains a TXOP for a frequency resource (or wireless medium) that is also utilized by shared AP 306, and determines (e.g., via a CoSR Control frame exchange) to share a time allocation of the TXOP with the shared AP 306.

The CoSR session 300 of this example includes performing a CoSR preparing stage in which sharing AP 302 transmits a CoSR initial control frame (CoSR ICF) 312 to shared AP 306, and shared AP 306 responds with an initial control response frame (CoSR ICR) 314. In an example, the CoSR ICF 312 is a protected/unprotected BSRP Trigger frame (or a newly defined Trigger frame) carrying CoSR-related control information, and the CoSR ICR 314 is a QoS Null frame or other type of frame that carries additional information/requirements of the shared AP 306. In the illustrated example, when at least one of the CoSR ICF 312 or CoSR ICR 314 is received by a STA 304, STA 308 and 310, medium protection for the entire TXOP is ensured for such STA.

The CoSR-related control information carried by the CoSR ICF 312 includes a set of PHY and transmission related parameters to negotiate and synchronize a CoSR session. Such parameters may include, for example, one or more of a PHY version of an intended downlink PPDU, a maximum transmit power limit allowed for the shared AP, a minimum and maximum number of OFDM symbols (which may be the same if fixed length is required), a transmit power the sharing AP intends to use in a downlink PPDU, a number of LTF symbols, bandwidth and punctured channel information for a PPDU, etc. Such parameters allow the shared AP 306 to evaluate whether it can safely transmit concurrently with the sharing AP 302. In an example, the CoSR-related control information may remain fixed for the duration of the TXOP. In another example, the CoSR-related control information may be dynamically adjusted (e.g., via a Trigger frame) to account for current network conditions and requirements.

Continuing with this example, CoSR ICR 314 transmitted by the shared AP 306 may include additional information such as a PHY version of a PPDU it intends to transmit, an intended transmit power (e.g., less than a limit set by the sharing AP 302), bandwidth and punctured channel information, a requested PPDU length, a number of data OFDM symbols, etc. Such information allows the sharing AP 302 to determine, for example, whether two synchronized transmissions can coexist under the applicable CoSR rules. In an example, the determination may employ algorithms (including reinforcement learning) to decide whether APs can transmit concurrently.

In the illustrated example, the sharing AP 302 of this example transmits a CoSR Trigger frame 316 following the initial ICF/ICR exchange. The CoSR Trigger frame 316 of this example (e.g., an updated BSRP Trigger frame) functions to schedule and synchronize transmission of CoSR data PPDUs by the sharing AP 302 and the shared AP 304. For example, the CoSR Trigger frame 316 may provide a common timing and phase reference and a transmission schedule for DL data transmissions such that the sharing AP 302 and the shared AP 304 can align transmissions.

In this example, following the CoSR Trigger frame 316, sharing AP 302 transmits a data PPDU 318 and shared AP 306 transmits a synchronized power controlled data PPDU 320 at a reduced power level (indicated in FIG. 3 by a shorter height PPDU). In relation to a data PPDU transmitted by a sharing AP, the term synchronized data PPDU as used herein may include a concurrently scheduled and/or concurrently transmitted data PPDU, an overlapping data PPDU, or a potentially concurrently transmitted data PPDU. Continuing with this example, the sharing STA 304 transmits an ACK frame 322 to acknowledge receipt of data PPDU 318, and shared STA 308 transmits an ACK frame 324 to acknowledge receipt of data PPDU 320.

In an example, subsequent synchronized DL data PPDUs are transmitted following RTS/CTS exchanges between sharing AP 302 and shared AP 306. In the illustrated example, the sharing AP 302 transmits (e.g., at full power) a Request to Send (RTS) frame 326 having a duration field set to reserve the medium until the end of the TXOP. In this example, the RTS frame 326 is addressed to the sharing AP 302.

In response to the RTS frame 326, the sharing AP 306 transmits a Clear to Send (CTS) frame 328. In this example, the CTS frame 328 is transmitted at full power level (e.g., a BSS power level) that is greater that the power level of the DL data PPDUs transmitted by shared AP 306. In an example, transmitting the RTS frame 326 and CTS frame 328 at full power prior to the next DL data PPDUs functions to protect the transmission medium in the event a station (e.g., non-intended shared STA 310) misses the initial ICF/ICR exchange and is unaware of the ongoing CoSR session for purposes of setting its basic NAV timer to indicate that the medium is busy. In such situations, the station may perform a channel assessment during a reduced power DL data PPDU transmission by shared AP 306, incorrectly determine that the medium is clear, and initiate a transmission that may interfere with CoSR operations.

In the illustrated example, following CTS frame 328, sharing AP 302 transmits a data PPDU 330 and shared AP 332 transmits a synchronized power controlled data PPDU 320 at a reduced power level. Continuing with this example, the sharing STA 304 transmits an ACK frame 334 to acknowledge receipt of data PPDU 318, and shared STA 308 transmits an ACK frame 336 to acknowledge receipt of data PPDU 320. The CoSR session 300 of this example further includes N-transmission sequences (CTS->DL PPDU->ACK) by sharing AP 302 and shared AP 306 that include RTS frame 338, CTS frame 340, data PPDU 342, data PPDU 344, ACK frame 346, and ACK frame 348. Any additional synchronized data PPDU transmissions are similarly preceded by an RTS/CTS frame exchange.

FIG. 4 illustrates another example of a frame exchange sequence for a power controlled CoSR session 400 in accordance with an embodiment of the present disclosure. In the illustrated example, the CoSR session 400 is performed between a sharing AP 402, a sharing STA 404 that is an intended recipient of DL data PPDUs from sharing AP 402, a shared AP 406, a shared STA 408 that is an intended recipient of DL data PPDUs from shared AP 406. The example further includes a non-intended shared STA 410.

The frame exchanges of the CoSR session 400 operate similarly to the frame exchanges of CoSR session 300 described with reference to FIG. 3. In particular, CoSR ICF 412, CoSR ICR 414, CoSR Trigger frame 416, data PPDU 418, power controlled data PPDU 420, ACK frame 422, ACK frame 424, data PPDU 430, power controlled data PPDU 432, ACK frame 434, ACK frame 436, data PPDU 442, data PPDU 444, ACK frame 446, and ACK frame 448 are transmitted as described with reference to the similarly labeled frames/PPDUs of FIG. 3 and serve analogous functions.

In the example of FIG. 4, however, the RTS/CTS frame exchanges of FIG. 3 are replaced by jointly transmitted CTS frames (without a preceding RTS frame) before each synchronized data PPDU transmission. In the illustrated example, the sharing AP 402 transmits a CTS frame 426 and the shared AP 406 simultaneously transmits CTS frame 428 prior to the synchronized transmission of data PPDU 430 and data PPDU 432. Likewise, sharing AP 402 transmits a CTS frame 438 and the shared AP 406 simultaneously transmits CTS frame 440 prior to the synchronized transmission of data PPDU 442 and data PPDU 444.

The simultaneously transmitted CTS frames of this example can have identical content fields to ensure that these fields do not collide at any station that is in the receiving range of both sharing AP 402 and shared AP 404. In an example, the Duration field of each jointly transmitted CTS frame is set to the remaining time in the TXOP beginning one SIFS duration after the transmission time of the CTS frame, and the Receiver Address (RA) field is set to a MAC address of sharing AP 402. Since some STAs in the BSS of shared AP 404 may not be able to detect the power controlled data PPDUs transmitted by shared AP 404, the periodic CTS frames can help to reserve the transmission medium for the shared AP 404 during the CoSR TXOP.

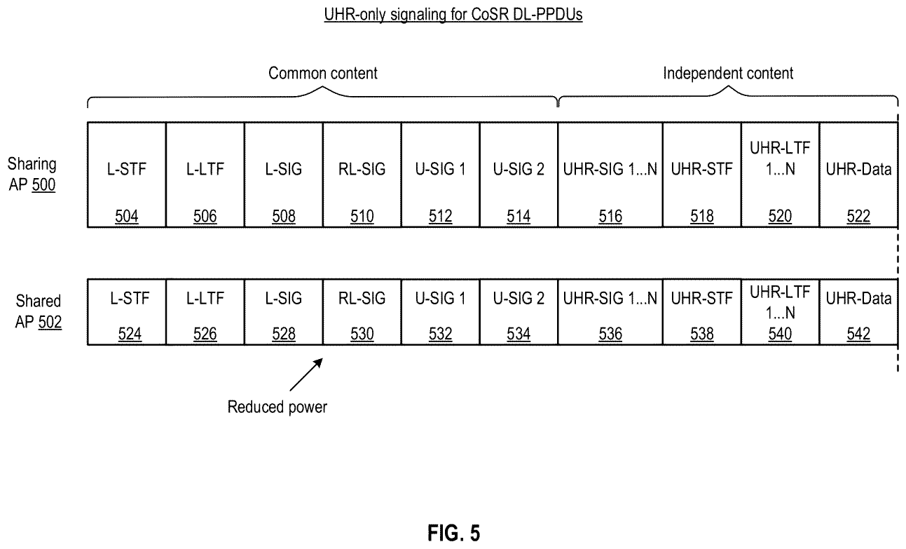

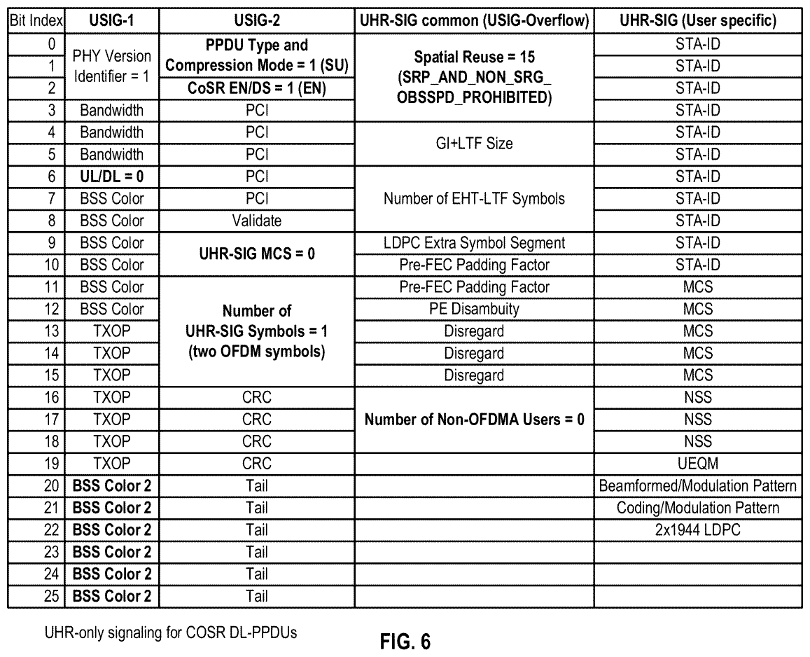

FIG. 5 illustrates examples of CoSR downlink data PPDU preamble signal fields and power control in accordance with embodiments of the present disclosure. In the illustrated examples, the preamble fields for synchronous data PPDUs transmitted by a sharing AP 500 and a shared AP 502 are shown. The illustrated preambles may correspond, for example, to preambles of the synchronized data PPDUs described with respect to FIG. 3 or FIG. 4. A specific example of the contents of a UHR PPDU preamble is described with reference to FIG. 6.

In the illustrated examples, the preamble of a data PPDU transmitted by sharing AP 500 includes a legacy short training field (L-STF) 504, a legacy long training field (L-LTF) 506, a legacy signal (L-SIG) field 508, a repeated L-SIG (RL-SIG) field 510, a U-SIG 1 field 512, a U-SIG 2 field 514, a UHR-SIG 1-N field 516, a UHR-STF 518, a UHR-LTF 1-N 520, and UHR-Data 522. The preamble fields of a (synchronized) data PPDU transmitted by shared AP 502 include L-STF 524, L-LTF 526, L-SIG field 528, RL-SIG 530, U-SIG 1 field 532, U-SIG 2 field 534, UHR-SIG 1-N field 536, UHR-STF field 538, UHR-LTF 1-N 540, and UHR-Data 542.

In an example, fields 504-514 of the data PPDU transmitted by sharing AP 500 and fields 524-534 of the data PPDU transmitted by shared AP 502 have common content, while the remaining fields of the respective data PPDUs have independent content specific to an intended recipient station. In the illustrated example, the (CoSR) data PPDU transmitted by shared AP 502 is transmitted at a reduced power level as compared to the data PPDU transmitted by sharing AP 500.

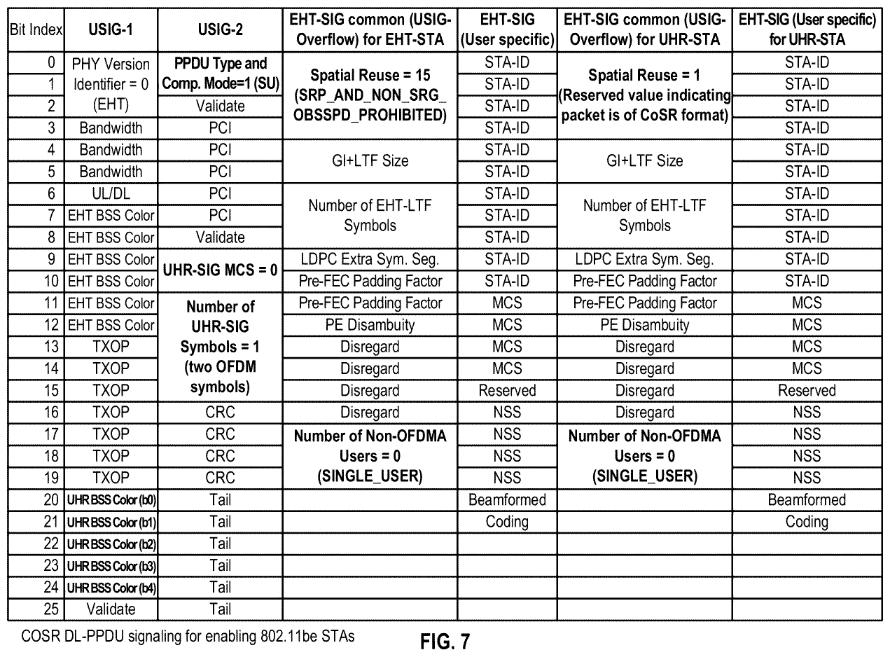

FIG. 6 illustrates an example of (redefined) CoSR UHR PPDU preamble signal fields in accordance with embodiments of the present disclosure. The UHR PPDU preamble fields of this example can be utilized for synchronous data PPDU transmissions when only UHR (802.11bn) stations participate in a CoSR session. An example of PPDU preamble signal fields that accommodate participation by both UHR and EHR (802.11be) stations is described with reference to FIG. 7.

In the USIG-1 field of the illustrated example, the PHY version identifier (bit index [0-2]) is set to 1, bit index [7-12] carries the BSS color of the sharing AP, and bit index [20-25] indicates the BSS color of the shared AP. In the USIG-2 field, bit index [0-1] is set to indicate a single user (SU) packet type and bit 2 is set to indicate that the PPDU is a CoSR PPDU. In addition, bit index [9-10] is set to indicate that the UHR-SIG MCS is 0 and bit index [11-15] indicates that the number of UHR-SIG symbols is two. Continuing with this example, in the UHR-SIG common field (also referred to as USIG-Overflow) bit index [0-3] is set to disable Overlapping BSS Packet Detection (OBSS/PD) and Parameterized Spatial Reuse (PSR) operations and bit index [16-18] is set to indicate that the number of users is 1 (Single User). In this example, there are no other restrictions on the other bits of the UHR-SIG fields.

In this example, since synchronized data PPDUs are identical through the USIG field (USIG-1 and USIG-2), the PPDUs will not collide at any receiving STA through these fields. In an example of operation, any non-intended recipient 802.11be STA that receives a data PPDU can decode the USIG-1 field, determine that the PHY version identifier is set to 1, and then abort packet processing early to save power. Likewise, any non-intended recipient 802.11bn STA in the sharing BSS or shared BSS that correctly receives the UHR-SIG fields of a data PPDU can exit packet processing due to STA-ID mismatch. Collisions between UHR-SIG fields will typically result in a CRC failure and aborted packet processing.

In a further example, an 802.11bn STA of a third BSS (i.e., outside of the sharing BSS and shared BSS) that receives a CoSR data PPDU will abort packet processing due to BSS color mismatch. In this example, the 802.11bn STA will refrain from transmitting (and causing additional interference) since the spatial reuse field in the UHR-SIG common field is set to disable spatial reuse as described above. In another example, 802.11ax and prior legacy devices will drop CoSR data PPDUs due to packet format mismatch (auto-detection).

Intended recipient 802.11bn STAs in the sharing BSS/shared BSS will determine that the first BSS color field (bit index [7-12] of the USIG-1 field) matches and as a result will proceed and find its associated STA-ID in the user-specific fields of the UHR-SIG. STA selection and power control limits determined by a shared AP in a CoSR session help ensure that UHR-SIG fields will not collide at either of the intended recipient STAs. Further, the disclosed signaling helps minimize the exchange of information between a sharing AP and a shared AP.

FIG. 7 illustrates examples of CoSR PPDU preamble signal fields that accommodate an EHR station in accordance with an embodiment of the present disclosure. In general, the PHY version identifier bits (of the U-SIG 1 field) and validate bits are unchanged from earlier versions of the 802.11 standard such that a recipient EHT STA does not abort packet processing. In the illustrated example, the packet format follows the 802.11be PPDU format and uses disregard bits for additional signaling. This design allows one of the recipient devices to be an EHT device, while the other is a UHR device.

In the USIG-1 field of the illustrated example, the PHY version identifier (bit index [0-2]) is set to 1 and bit index [20-24] indicates the first five bits of the BSS color of the UHR BSS. In the USIG-2 field, bit index [0-1] is set to indicate a single user (SU) packet type, bit index [9-10] is set to indicate that the UHR-SIG MCS is 0, and bit index indicates that the number of UHR-SIG symbols is two OFDM symbols.

For an EHT STA, in this example bit index [0-3] of the EHT-SIG common field (USIG-Overflow) is set to disallow OBSS/PD and PSR operations to minimize potential interference. For a UHR STA, bit index [0-3] of the USIG-Overflow field are set to a reserved value to indicate that the PPDU type is CoSR. Contingent on this indication, the UHR STA matches bits 20-24 of the USIG-1 field with the first five bits of its own BSS color. In addition, bit index [17-19] of the USIG-Overflow field is set to indicate that the number of users is 1 (Single User).

In another example, one of the disregard bits (bit index [13-16] of the USIG-Overflow field can be used to indicate the last bit of a UHR STA's BSS color. In a further example, the UHR-SIG for a UHR-STA can be in UHR format even though the PHY version identifier indicates 0, and a reserved value of the spatial reuse field can be used to indicate the PPDU type as CoSR. A disregard bit from the USIG-Overflow field (bit index [13-15]) can optionally indicate the last bit of the UHR STA's BSS color.

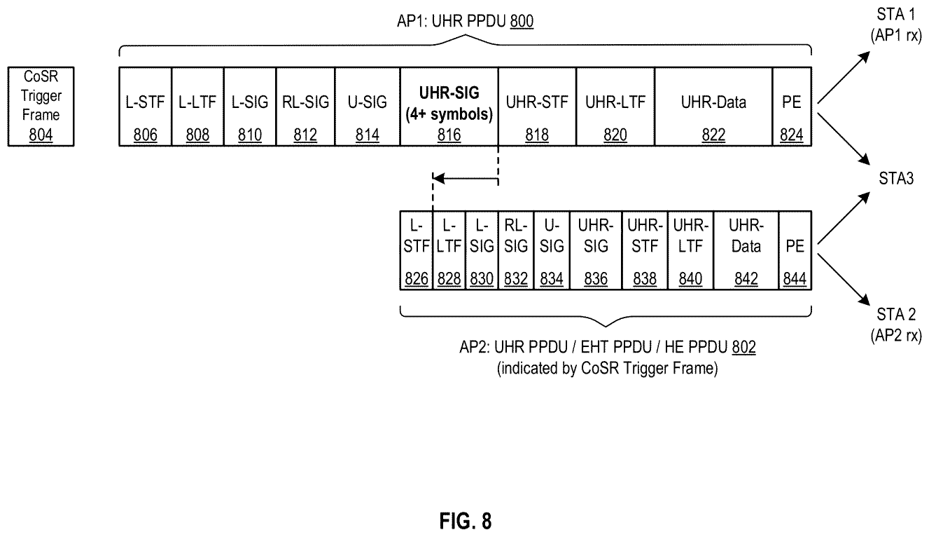

FIG. 8 illustrates an example of a protocol for asynchronous CoSR in accordance with an embodiment of the present disclosure. As used herein, asynchronous CoSR transmission refers to a mode of Coordinated Spatial Reuse (CoSR) in which devices transmit without tight time-synchronization, allowing each node to make independent reuse decisions rather than following a shared schedule.

In the illustrated example, following a CoSR Trigger frame 804, AP1 transmits UHR PPDU 800 for receipt by STA 1 and AP2 transmits UHR PPDU/EHT PPDU/HE PPDU 802 (as indicated by the CoSR Trigger frame 804) for receipt by STA 2. In this example, the UHR PPDU 800 includes L-STF 806, L-LTF 808, L-SIG field 810, RL-SIG field 812, U-SIG field 814, a UHR-SIG field 816 including four or more symbols, UHR-STF 818, a UHR-LTF 820, UHR-Data 822, and Packet Extension (PE) field 824. The preamble fields of PPDU 802 include L-STF 826, L-LTF 828, L-SIG field 830, RL-SIG 832, U-SIG field 834, UHR-SIG field 836, UHR-STF 838, UHR-LTF 840, UHR-Data 842, and PE field 844.

In previously proposed approaches to asynchronous CoSR, a shared AP can transmit a PPDU after the U-SIG portion of a sharing AP's PPDU. The U-SIG symbol of the sharing AP is proposed to contain CoSR signaling, and the shared AP is supposed to receive the sharing AP's PPDU, read the CoSR indication from the U-SIG symbol, and then transmit its PPDU to a shared STA. One potential issue in this scheme is that the L-STF portion of the shared AP's PPDU can potentially overlap with sharing AP's PPDU, which may cause issues with packet detection and symbol timing at the shared STA.

If the shared STA can decode the U-SIG field of the sharing AP's PPDU, it knows the number of UHR-SIG symbols and the location of the UHR-STF of the sharing STA. However, if the sharing AP's PPDU arrives at much lower SNR such that the signal fields cannot be decoded, then the sharing STA has no way of knowing it is receiving an asynchronous CoSR transmission. It is possible that the UHR-STF can still excite the packet detection state machine of the sharing STA (since packet detection typically operates at a lower SNR compared to the requirements for data decoding). If the L-STF of the shared AP's PPDU follows soon after the shared STA has locked onto the sharing AP's PPDU, the Carrier Sense state machine of the shared STA may not be able to unlock from its ongoing engagement and lock on to the shared AP's L-STF.

To avoid this scenario, in the embodiment of FIG. 8 a sharing AP uses at least 4 UHR-SIG symbols in the UHR-SIG field 816. In this manner, a shared AP will have sufficient time (including Tx-Rx turnaround time) to complete its L-STF 826 transmission before the start of the UHR-STF 818. In another example, if the required number of UHR-SIG symbols is less than 4, dummy User Info fields can be introduced in the UHR PPDU 800.

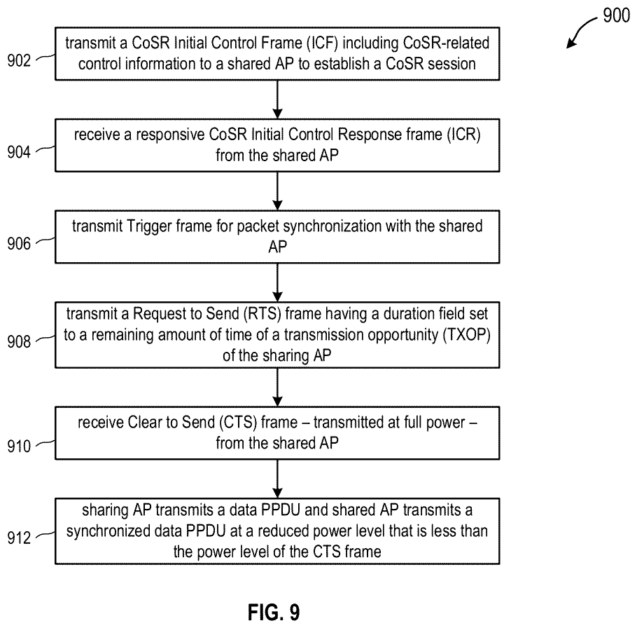

FIG. 9 is a flow chart illustrating an example method 900 for performing a CoSR frame exchange in accordance with embodiments of the present disclosure. The method 900 can be performed by a (sharing) AP, such as the AP MLD 102 described with reference to FIG. 1, the sharing AP 202 described with reference to FIG. 2, or the AP/MLD 1000 described with reference to FIG. 10. The method 900 may be utilized, for example, to perform a CoSR frame exchange during a single TXOP.

The method of this example illustrates a CoSR frame exchange between a sharing AP and a shared AP, which begins at step 902 where a sharing A8P transmits a CoSR Initial Control Frame (ICF) (e.g., a BSRP Trigger frame or newly defined Trigger frame) to a shared AP to establish a CoSR session. The CoSR-related control information may include, for example, one or more of a PHY version of an intended downlink PPDU, a maximum transmit power limit allowed for the shared AP, a minimum and maximum number of OFDM symbols (which may be the same if fixed length is required), a transmit power the sharing AP intends to use in a downlink PPDU, a number of LTF symbols, bandwidth and punctured channel information for a PPDU, etc. Such parameters allow the shared AP to evaluate whether it can safely transmit concurrently with the sharing AP.

The method continues at step 904, where the sharing AP receives a CoSR Initial Control Response frame (ICR) from the shared AP in response to the CoSR ICF. The ICR may include additional information such as a PHY version of a PPDU it intends to transmit, an intended transmit power (e.g., less than a limit set by the sharing AP), bandwidth and punctured channel information, a requested PPDU length, a number of data OFDM symbols, etc. Such information allows the sharing AP to determine whether two transmissions can coexist under the applicable CoSR rules. In the illustrated method, at step 906 the sharing AP further transmits a Trigger frame (or Sync frame) for packet synchronization with the shared AP.

The method continues at step 908, where the sharing AP transmits a Request to Send (RTS) frame having a duration field set to a remaining amount of time of a transmission opportunity (TXOP) held of sharing AP (e.g., beginning one SIFS duration after the transmission time of RTS frame). In response, the shared AP transmits (at step 910) a Clear to Send (CTS) frame that is received by the sharing AP. In the illustrated example, the RTS frame and CTS frame are transmitted at full power for purposes of protecting the medium from interference from STAs that are not intended recipients of a power controlled data PPDU. For example, a STA in a BSS of the shared AP (or a nearby OBSS) that is not an intended recipient of a power controlled data PPDU may miss the ICR, and may therefore be otherwise unaware of an ongoing TXOP that includes a CoSR session. Such a STA may sense the medium during an ongoing data PPDU transmission (at a reduced power level) and incorrectly sense the medium as free. As a result, the STA might initiate a transmission that can interfere with reception of the data PPDU by an intended recipient STA.

The illustrated method continues at step 912, where the sharing AP transmits a data PPDU and the shared AP transmits a synchronized (e.g., overlapping) data PPDU at a reduced power level. In an example, the shared AP transmits the synchronized data PPDU at a power level that is less than the power level used to transmit its CSR frame.

FIG. 10 illustrates an example of a wireless device that is configured as an access point (AP) or AP multi-link device (MLD) according to embodiments of the present disclosure. The illustrated AP/MLD 1000 is configurable to support CoSR protocols and frame exchanges according to any of the various embodiments described herein. The AP/MLD 1000 of this example includes a host processor 1002 coupled to a network interface device 1004. The network interface device 1004 includes a medium access control (MAC) processing unit 1006 and a physical layer (PHY) processing unit 1008. The PHY processing unit 1008 includes a plurality of transceivers 1010 coupled to a plurality of antennas 1012. Although three transceivers 1010 (1010-1, 1010-2 and 1010-3) and three antennas 1012 (1012-1, 1012-2 and 1012-3) are illustrated in FIG. 1, the AP/MLD 1000 includes other suitable numbers (e.g., 1, 2, 4, 5, etc.) of transceivers 1010 and antennas 1012 in other embodiments. In an example, the MAC processing unit 1006 and the PHY processing unit 1008 are configured to operate in compliance with the IEEE 802.11bn amendment to the IEEE 802.11 standard. In an example, the network interface device 1004 includes one or more integrated circuit (IC) devices. In this example, at least some of the functionality of the MAC processing unit 1006 and at least some of the functionality of the PHY processing unit 1008 can be implemented on a single IC device. As another example, at least some of the functionality of the MAC processing unit 1006 is implemented on a first IC device, and at least some of the functionality of the PHY processing unit 1008 is implemented on a second IC device. The AP/MLD 1000 may communicate with a plurality of (MLD) client stations and/or APs (not separately illustrated), including both legacy and non-legacy client stations.

In various embodiments, the PHY processing unit 1008 of the AP/MLD 1000 is configured to generate data units conforming to a non-legacy communication protocol and having formats described herein. The transceiver(s) 1010 is/are configured to transmit the generated data units via the antenna(s) 1012. Similarly, the transceiver(s) 1010 is/are configured to receive data units via the antenna(s) 1012. The PHY processing unit 1008 of the AP/MLD 1000 is configured to process received data units conforming to the non-legacy communication protocol and having formats described herein and to determine that such data units conform to the non-legacy communication protocol.

In an embodiment, when operating in single-user mode, the AP/MLD 1000 transmits a data unit to a single client station (DL SU transmission), or receives a data unit transmitted by a single client station (UL SU transmission), without simultaneous transmission to, or by, any other client station. When operating in multi-user mode, the AP/MLD 1000 transmits a data unit that includes multiple data streams for multiple client stations (DL MU transmission), or receives data units simultaneously transmitted by multiple client stations (UL MU transmission). For example, in multi-user mode, a data unit transmitted by the AP/STA includes multiple data streams simultaneously transmitted by the AP/MLD 1000 to respective client stations using respective spatial streams allocated for simultaneous transmission to the respective client stations and/or using respective sets of OFDM tones corresponding to respective frequency subbands allocated for simultaneous transmission to the respective client stations. In a further example, the AP/MLD 1000 may be configured as a multi-link device, such as the AP MLD 102 described above with reference to FIG. 1, or the sharing AP 202 or shared AP 204 described above with reference to FIG. 2.

While the innovate aspects of the present disclosure have been generally described in the context of the 802.11bn amendment, and future generations, of the IEEE 802.11 standard, a person having ordinary skill in the art will readily recognize that teachings herein may be applied to other wireless networks and standards including, for example, cellular network standards and Bluetooth standards.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a processing core, processing circuitry, computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

As may be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may further be used herein, the term(s) “arranged to”, “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with” includes direct and/or indirect coupling of separate items and/or one item being embedded within another item.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processor”, “processing circuitry”, “processing circuit”, “processing module”, and/or “processing unit” may be a single processing device or a plurality of processing devices. Such a processing device may be a microprocessor, microcontroller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Further, such a processing device may include a plurality of processing cores or processing domains, which may operate on separate power domains. The processor, processing circuitry, processing circuit, processing module, and/or processing unit may be (or may further include) memory and/or an integrated memory element, which may be a single memory device, a plurality of memory devices, and/or embedded circuitry of another processor, processing circuitry, processing circuit, processing module, and/or processing unit. Such a memory device may be a read-only memory, random access memory, volatile memory, non-volatile memory, static memory, dynamic memory, flash memory, cache memory, and/or any device that stores digital information. Note that if the processor, processing circuitry, processing circuit, processing module, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processor, processing circuitry, processing circuit, processing module, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processor, processing circuitry, processing circuit, processing module, and/or processing unit executes, hard coded and/or operational instructions corresponding to at least some of the steps and/or functions illustrated in one or more of the figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the logic diagram block boundaries and sequence could have been defined otherwise and still perform the certain significant functionality. Such alternate definitions of both functional building blocks and logic diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors/processing cores executing appropriate software and the like or any combination thereof.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” may be used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for performing a Coordinated Spatial Reuse (CoSR) downlink data transmission by a first access point (AP) of a wireless network, the method comprising:
transmitting CoSR-related control information to establish a CoSR session with a second AP;
transmitting a Trigger frame for packet synchronization with the second AP;
transmitting a Request to Send (RTS) frame having a duration field set to a remaining amount of time of a transmission opportunity (TXOP) of the first AP;
receiving, in response to the RTS frame, a Clear to Send (CTS) frame from the second AP, wherein the CTS frame is transmitted at a first power level; and
transmitting a data physical layer protocol data unit (PPDU), wherein the CoSR-related control information from the first AP directs the second AP to transmit a synchronized data PPDU at a reduced power level that is less than the first power level of the CTS frame.

2. The method of claim 1, wherein transmitting CoSR-related control information to the second AP includes:
transmitting a CoSR Initial Control Frame (ICF); and
in response to the ICF, receiving a CoSR Initial Control Response frame (ICR) from the second AP.

3. The method of claim 1, wherein the data PPDU transmitted by the first AP includes a universal signaling (U-SIG) field including a U-SIG-1 field and a U-SIG-2 field, and wherein the U-SIG-1 field includes first bits corresponding to a Basic Service Set (BSS) color of the first AP and second bits corresponding to a BSS color of the second AP, and the U-SIG-2 field includes one or more bits set to indicate that the data PPDU is a Single User (SU) PPDU.

4. The method of claim 3, wherein the synchronized data PPDU transmitted by the second AP includes a U-SIG field including a U-SIG-1 field and a U-SIG-2 field, and wherein the U-SIG-1 field includes bits corresponding to the BSS color of the first AP and second bits corresponding to the BSS color of the second AP, and the U-SIG-2 field includes one or more bits set to indicate that the synchronized data PPDU is a Single User (SU) PPDU.

5. The method of claim 4, wherein the data PPDU transmitted by the first AP and the synchronized data PPDU transmitted by the second AP further include a UHR-SIG common field having one or more bits set to disable Overlapping BSS Packet Detection (OBSS/PD) and Parameterized Spatial Reuse (PSR) operations.

6. The method of claim 4, wherein the U-SIG-2 field of the data PPDU and the U-SIG-2 field of the synchronized data PPDU transmitted by the second AP further include one or more bits set to indicate a CoSR PPDU.

7. The method of claim 1, wherein the data PPDU transmitted by the first AP includes:
a U-SIG-1 field including PHY version identifier bits set to 0, first bits corresponding to an Extremely High Throughput (EHT) Basic Service Set (BSS) color and second bits corresponding to a Ultra High Reliability (UHR) BSS color; and
a U-SIG-2 field including two bits set to indicate that the data PPDU is a Single User (SU) PPDU.

8. The method of claim 7, wherein the data PPDU is intended for an EHT STA and further includes an EHT-SIG common field having bit index [0-3] set to disable Overlapping BSS Packet Detection (OBSS/PD) and Parameterized Spatial Reuse (PSR) operations and bit index [17-19] set to indicate that the data PPDU is a Single User (SU) PPDU.

9. The method of claim 7, wherein the data PPDU is intended for a UHR STA and further includes an EHT-SIG common field having bit index [0-3] set to a reserved value that indicates a CoSR PPDU and bit index [17-19] set to indicate that the data PPDU is a Single User (SU) PPDU.

10. The method of claim 1, wherein the CoSR downlink data transmissions are asynchronous, and wherein the data PPDU transmitted by the first AP includes:
a universal signaling (U-SIG) field including a U-SIG-1 field and a U-SIG-2 field, wherein the U-SIG-1 field includes first bits corresponding to a Basic Service Set (BSS) color of the first AP and second bits corresponding to a BSS color of the second AP, and the U-SIG-2 field includes one or more bits set to indicate that the data PPDU is a Single User (SU) PPDU; and
a UHR-SIG field that includes at least four symbols.

11. The method of claim 1, wherein the first AP is a sharing AP with respect to a transmission opportunity (TXOP) that includes the CoSR session, and the second AP is a shared AP with respect to the TXOP.

12. A method for performing a Coordinated Spatial Reuse (CoSR) downlink data transmission by a first access point (AP) of a wireless network, the method comprising:
transmitting CoSR-related control information to establish a CoSR session with a second AP;
transmitting a first Clear to Send (CTS) frame having a duration field set to a remaining amount of time of a transmission opportunity (TXOP) of the first AP beginning one SIFS duration after the transmission time of the first CTS frame, the first CTS frame further having a Receiver Address (RA) field set to a MAC address of the first AP; and
transmitting a data physical layer protocol data unit (PPDU), wherein the CoSR-related control information from the first AP directs the second AP to:
transmit a second CTS frame concurrently with the first CTS frame, the second CTS frame having a duration field set to a remaining amount of time of the TXOP and a RA field set to the MAC address of the first AP; and
transmit a CoSR data PPDU, wherein the second CTS frame is transmitted at a full power level and the CoSR data PPDU is transmitted at a reduced power level.

13. The method of claim 12, wherein transmitting CoSR-related control information to the second AP includes:
transmitting a CoSR Initial Control Frame (ICF); and
in response to the ICF, receiving a CoSR Initial Control Response frame (ICR) from the second AP.

14. The method of claim 12, wherein the data PPDU transmitted by the first AP includes a universal signaling (U-SIG) field including a U-SIG-1 field and a U-SIG-2 field, and wherein the U-SIG-1 field includes first bits corresponding to a Basic Service Set (BSS) color of the first AP and second bits corresponding to a BSS color of the second AP, and the U-SIG-2 field includes one or more bits set to indicate that the data PPDU is a Single User (SU) PPDU.

15. The method of claim 14, wherein the CoSR PPDU transmitted by the second AP includes a U-SIG field including a U-SIG-1 field and a U-SIG-2 field, and wherein the U-SIG-1 field includes bits corresponding to the BSS color of the first AP and second bits corresponding to the BSS color of the second AP, and the U-SIG-2 field includes one or more bits set to indicate that the CoSR PPDU is a Single User (SU) PPDU.

16. An access point (AP), comprising:
one or more wireless transceivers; and
one or more processors operably coupled to the one or more wireless transceivers, wherein the one or more processors are arranged to:
transmit CoSR-related control information to establish a CoSR session with a second AP;
transmit a Trigger frame for packet synchronization with the second AP;
transmit a Request to Send (RTS) frame having a duration field set to a remaining amount of time of a transmission opportunity (TXOP) of the AP;
receive, in response to the RTS frame, a Clear to Send (CTS) frame from the second AP, wherein the CTS frame is transmitted at a first power level; and
transmit a data physical layer protocol data unit (PPDU), wherein the CoSR-related control information from the AP directs the second AP to transmit a synchronized data PPDU at a reduced power level that is less than the first power level of the CTS frame.

17. The AP of claim 16, wherein transmitting CoSR-related control information to the second AP includes:
transmitting a CoSR Initial Control Frame (ICF); and
in response to the ICF, receiving a CoSR Initial Control Response frame (ICR) from the second AP.

18. The AP of claim 16, wherein the data PPDU transmitted by the AP includes a universal signaling (U-SIG) field including a U-SIG-1 field and a U-SIG-2 field, and wherein the U-SIG-1 field includes first bits corresponding to a Basic Service Set (BSS) color of the AP and second bits corresponding to a BSS color of the second AP, and the U-SIG-2 field includes one or more bits set to indicate that the data PPDU is a Single User (SU) PPDU.

19. The AP of claim 18, wherein the data PPDU transmitted by the AP further includes a UHR-SIG common field having one or more bits set to disable Overlapping BSS Packet Detection (OBSS/PD) and Parameterized Spatial Reuse (PSR) operations.

20. The AP of claim 18, wherein the synchronized data PPDU transmitted by the second AP includes a U-SIG field including a U-SIG-1 field and a U-SIG-2 field, and wherein the U-SIG-1 field includes bits corresponding to the BSS color of the AP and second bits corresponding to the BSS color of the second AP, and the U-SIG-2 field includes one or more bits set to indicate that the synchronized data PPDU is a Single User (SU) PPDU.
